(19) United States
(12) Patent Application Publication
(10) Pub. No.: US 2008/0024365 A1
(43) Pub. Date: Jan. 31, 2008

(54) Position finding system and method used with an emergency beacon

(76) Inventors: Kevin Conrad Holmes, Kelowna (CA); William Austin Street, Kelowna (CA)

Correspondence Address: ANTONY C. EDWARDS, SUITE 200 - 270 HIGHWAY 33 WEST, KELOWNA, BC, V1X 1X7, CA

(21) Appl. No.: 11/882,172

(22) Filed: Jul. 31, 2007

Related U.S. Application Data
(60) Provisional application No. 60/834,294, filed on Jul. 31, 2006.

(51) Int. Cl. G01S 5/00; G01S 1/00; G01S 3/00

(52) U.S. Cl. 342/418; 342/357.12; 342/417; 342/450; 342/451

(57) ABSTRACT

Disclosed is an apparatus and method for locating a transmitter. The apparatus comprises an antenna, a receiver and a memory adapted to store the plurality signals received by the receiver and antenna. The plurality of signals represents a plurality of data points relating to the position of the transmitter as measured at a plurality of unique locations. The location of the transmitter is calculated using the plurality data points. The plurality of data points may represent a measured frequency of a signal transmitted by the transmitter a direction of the transmitter or any other type of data. The method may comprise utilizing the Doppler shift rate of change of an assumed transmitted frequency to calculate a conical surface. The calculated intersection of a plurality of conical surfaces to defines the location of the transmitter.

### CROSS REFERENCE TO RELATED APPLICATION

This application claims priority from U.S. Provisional Patent Application No. 60/834,294 filed Jul. 31, 2006 entitled Position Finding System and Method Used with an Emergency Beacon.

### FIELD OF THE INVENTION

This invention relates to locating a transmitter in general and in particular to a system and method for locating an emergency beacon using a single receiver system adapted to receive a plurality of data points relating to a signal outputted by the emergency beacon.

### BACKGROUND OF THE INVENTION

In many circumstances it is necessary to locate the position of a transmitter for example in search and rescue (SAR) operations. In such SAR operations, an aircraft such as a helicopter or airplane, which has a receiver will search an area for the location of a lost person or object having an associated emergency beacon. The emergency beacon emits a continuous or intermittent radio frequency signal which is received by the receiver on the aircraft. The aircraft then utilizes information relating to signal emitted from the transmitter such as the direction of the transmitter relative to the receiver to determine the location of the transmitter.

In most SAR operations it is necessary to locate the emergency beacon as quickly as possible. This may be due to a time limitation for the person being searched for such as a critical medical emergency or fuel limitations within the SAR aircraft. In a helicopter rescue scenario, for example, fuel consumption is always a major concern. The sooner a helicopter can arrive at the target transmitter the longer it can stay on scene to aid in assisting or extracting the survivors. Instances have been cited where SAR aircraft have spent too much time homing on a beacon and had to leave the scene prior to extracting all of the survivors due to fuel supplies running low. An EH101 Cormorant helicopter has a typical fly time of approximately 4 hours per tank of fuel. A smaller Cessna (typical aircraft used by civilian SAR—CASARA) can operate for 3-5 hours per tank. These valuable minutes can easily be used up when flying a long distance to an incident and if an inordinate amount of time is used for homing.

Previous methods of determining the location of the transmitter using a single receiver have been unsatisfactory. Due to some ambiguities in the data conveyed by the transmitter signal, single receivers have not been able to determine the exact location of the transmitter with a great deal of accuracy. Many of these prior methods also require the use of multiple receivers for receiving the signal from the transmitter where the data received at each of the receivers are used to triangulate the position of the transmitter. Examples of such systems may be found, in U.S. Pat. Nos. 4,728,959, 4,799,062, 5,592,180 and 5,815,117. For SAR purposes, it is not often possible to use multiple receivers due to the remote location of the emergency beacon and the lack of time to set up and co-ordinate multiple receives within such a remote location.

Applicant is also aware of many problems that exist with the current 121.5 MHz tracking abilities as are commonly known in the art. Examples of such problems include multipath and confusing Receive Signal Strength Indicators (RSSI) readings due to motion and antenna patterns of the transmitter and receiver.

Current direction finding techniques also have poor resolution of direction and indicate a heading only, not a position. Current direction finding techniques often utilize costly antennas. These antennas provide a direction to the beacon from the receiver. Successive directions at subsequent locations are used to progressively narrow the location of the beacon. Due to their large size these antennas can cause undesirable drag and handling characteristics for faster moving aircraft. Current direction finding techniques also require a great deal of attention and understanding from the pilot and can distract from other mission criteria and safety.

What is desired is a system and method of position finding for use in the search and rescue community that may utilize a single receiver and be able to locate the position of the emergency beacon with greater accuracy and efficiency.

### SUMMARY OF THE INVENTION

The present invention is an emergency beacon receiver that calculates the geographical position of the homing transmitter radiated from an emergency beacon.

This invention provides a SAR receiver that determines the position of an emergency beacon that has incorporated a homing transmitter, which is frequency stabilized. The receiver detects the homing signal and calculates and displays the position of the emergency beacon. The object is to alleviate many of the technical issues and operation issues that standard direction finding receivers can cause.

According to a first embodiment of the present invention there is provided a method of locating a transmitter. The method comprises providing a receiver adapted to receive signals from the transmitter and acquiring a plurality of data points relating to the position of the transmitter. Each of the plurality of data points corresponds a unique location of the receiver. The method also includes calculating the location of the transmitter using the plurality data points.

The plurality of data points may represent a measured frequency of a signal transmitted by the transmitter. The plurality of data points may comprise at least three measured frequencies. The plurality of measured frequencies may each include an associated speed and position of the receiver.

Calculating may comprise utilizing the plurality of measured frequencies and their corresponding speed and position of the receiver so as to calculate the position of the transmitter. Calculating may comprise assuming a transmitted frequency of the transmitter based upon the speed of the receiver and for each of the plurality of measured frequencies calculating an angle of orientation of the transmitter relative to the receiver utilizing the Doppler shift of the measured frequency relative to the assumed transmitted frequency. The angle orientation defines a conical surface. The method may further include calculating the intersection of the plurality of the conical surfaces to determine said location of the transmitter. Calculating the intersection may utilize a computer. Calculating may be performed using computational geometry.

The plurality of data points may represent a direction of said transmitter relative to the receiver at a unique location of the receiver. The receiver may comprise a direction finding antenna adapted to determine the angle of the transmitter relative to the receiver. The receiver may have a phased array antenna. The receiver may have an electronic compass for measuring the orientation of the receiver.

The plurality of data points may comprise at least two data points. Calculating may comprise calculating the intersection of the at least two directions.

According to a further embodiment of the present invention, there is provided an apparatus for locating a transmitter. The apparatus comprises an antenna adapted to receive signals from the transmitter, a receiver adapted to receive the plurality of signals from the antenna and a memory adapted to store the plurality signals received from the receiver. The plurality of signals represent a plurality of data points relating to the position of the transmitter wherein each of the plurality of data points corresponding a unique location of the receiver. The apparatus further includes a processor for calculating the location of the transmitter using the plurality data points stored in the memory and an output for outputting the location of the transmitter as calculated by the processor.

The apparatus may further comprise a global positioning receiver for receiving data representing the global position of the receiver wherein the processor utilizes the data representing the global position of the receiver to calculate the global position of the transmitter.

### BRIEF DESCRIPTION OF THE DRAWINGS

In drawings which illustrate embodiments of the invention,

FIG. 1 is a diagrammatic view of a search and rescue helicopter having a receiver searching for a transmitter in an emergency beacon.

FIG. 2 is a diagrammatic plan view of the aircraft and transmitter of FIG. 1 during a search and rescue operation at a first time period.

FIG. 3 is the view of FIG. 2 during a search and rescue operation at a second time period.

FIG. 4 is a view of the conical surfaces of FIGS. 2 and 3 superimposed on each other to produce an intersection path of the first and second conical surfaces.

FIG. 4a is a planar view of an aircraft having an antenna of FIG. 4 illustrating the first second and third angles of the location of an emergency beacon.

FIG. 5 is a schematic block diagram of a receiver according to one embodiment of the present invention.

FIG. 6 is a diagrammatic plan view of a handheld receiver system at two positions during a search and rescue operation to locate a transmitter.

### DETAILED DESCRIPTION OF EMBODIMENTS OF THE INVENTION

The present invention uses a combination of Doppler tracking with Global Navigation Satellite System (GNSS) positioning information in order to determine the geographical position of the emergency beacon. A receiver that is slow moving or stationary may also need an antenna array to determine direction to the transmitter and an electronic compass to determine receiver orientation.

The Doppler principle states that the measured frequency of a wave is relative to the motion between the source and the observer. This Doppler shift is observed when the receiver is in motion and the transmitter stationary. This allows the receiver to monitor the rate of change of the Doppler shift. The specific rate of change correlates to a relative position of the target transmitter. Since the receiver knows its own position through GNSS it can convert the relative transmitter position to absolute position coordinates.

In one application which is not intended to be limiting the receiver according to the present invention is mounted aboard a search and rescue airplane that is in flight. The receiver will continually receive the stable homing signal from the emergency beacon, calculate the frequency received and save this information along with its GNSS position and time information. These data points are continually stored in memory and used in a calculation that observes the Doppler shift rate of change. The Doppler shift rate of change can only fit one of two possible solution of the position of emergency beacon (assuming it is on the surface of the earth), the real solution and its image. The image can be eliminated as a possible solution by having the search aircraft change it's flight path. A change in flight path will eliminate the image by creating another real solution and a different image. The real solution is the only solution that will remain constant. The accuracy and resolution of the position of the emergency beacon will improve as the plane gets closer and as more data points are collected.

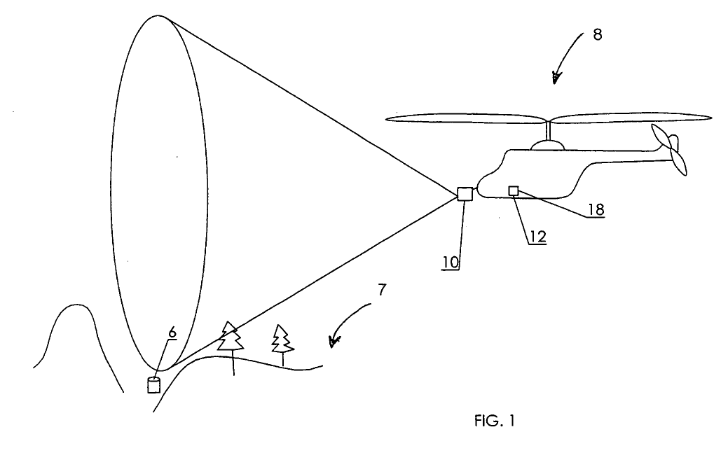

Referring to FIG. 1, in a search and rescue (SAR) operation, an aircraft 8, such as by way of non-limiting example a helicopter or an airplane, having an antenna 10 searches a geographic area generally indicated at 7 for a transmitter 6. The helicopter 8 also has a GNSS also known as a GPS antenna and receiver to provide the location of the helicopter at any given time. The transmitter 6 may be an emergency beacon which may be an Emergency Position Indicating Radio Beacon (EPIRB), an Emergency Locator Transmitter (ELT), or a Personal Locator Beacon (PLB) or any other emergency type beacon that transmits a continuous homing signal as are known in the art.

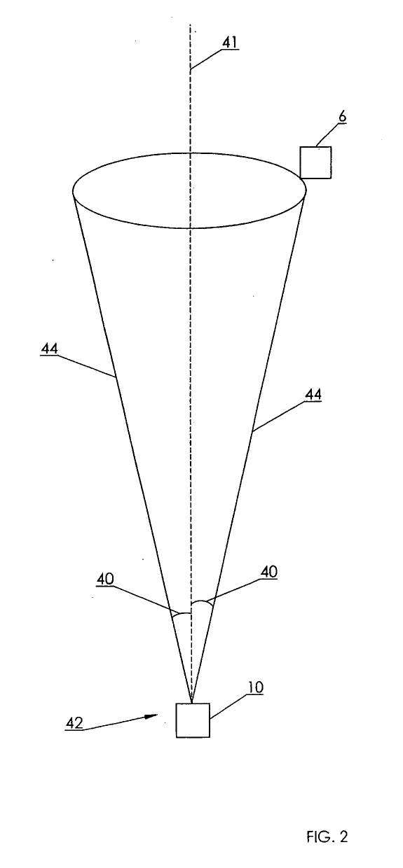

Referring now to FIG. 2, antenna 10 is shown at a first position 42 having a first forward orientation 41 while searching for transmitter 6. The antenna 10 receives the radio frequency (RF) signal transmitted by the transmitter. In the example shown in FIG. 2 antenna 10 is mounted to an aircraft 8 having a forward direction of movement parallel to the first forward orientation 41 of the antenna 10.

It is known that a signal transmitted by a stationary transmitter 6 that is received by a moving antenna 10 will experience a shift in the measured frequency from the transmitted frequency known as the Doppler shift. According to the Doppler shift, it is also known that the frequency of the measured signal at the antenna will be higher than the transmitted signal while the antenna is moving towards the transmitter. Conversely, the measured signal will be lower than the transmitted signal when the antenna is moving away from the transmitter. In addition, it is also well known that the rate of change of the Doppler shift from positive to negative as the antenna approaches and then moves away from the transmitter can be utilized to determine the angle of the transmitter from the forward direction of movement of the antenna.

As illustrated in FIG. 2, the antenna 10 measures the Doppler shift rate of change of the signal transmitted by the transmitter 6. By the method and apparatus as described further below, the first angle 40 of the transmitter 6 from the antenna 10 direction 41 is calculated for the first position 42. It will be seen in FIG. 2, that although the angle from the antenna is known which direction this angle 40 is oriented relative to the antenna. Accordingly the location of the transmitter 6 relative to the antenna 10 is known to be located on a conical surface 44 having an axis concentric with the first forward orientation 41 of the antenna at the first position 46.

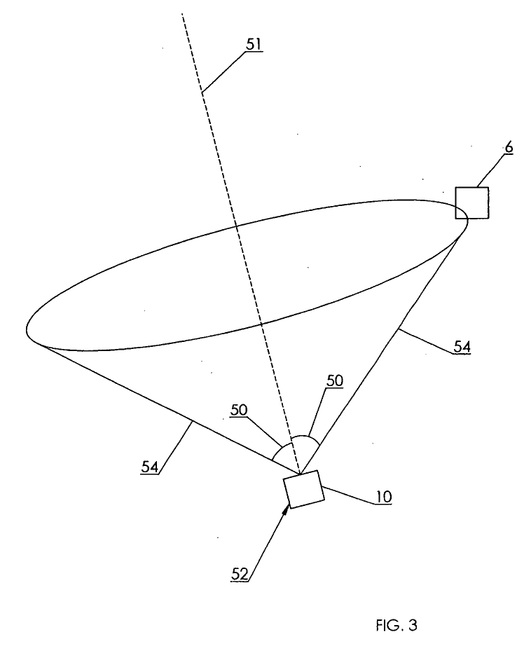

Turning now to FIG. 3, the antenna 10 is shown at a second position 52 having a second forward orientation 51 while searching for transmitter 6. The antenna 10 receives the RF signal transmitted by the transmitter. As illustrated in FIG. 3, the antenna 10 measures the Doppler shift rate of change of the signal transmitted by the transmitter 6. By the method and apparatus as described further below, the second angle 50 of the transmitter 6 from the antenna 10 direction 51 is calculated for the first position 52. As described above, the location of the transmitter is therefore calculated to be located upon a conical surface. As was illustrated in FIG. 2, again as illustrated in FIG. 3, although the angle from the antenna is known, it is not known which direction this angle 50 is oriented relative to the antenna. Accordingly the location of the transmitter 6 relative to the antenna 10 is known to be located on a conical surface 54 having an axis concentric with the first forward orientation 51 of the antenna at the second position 52.

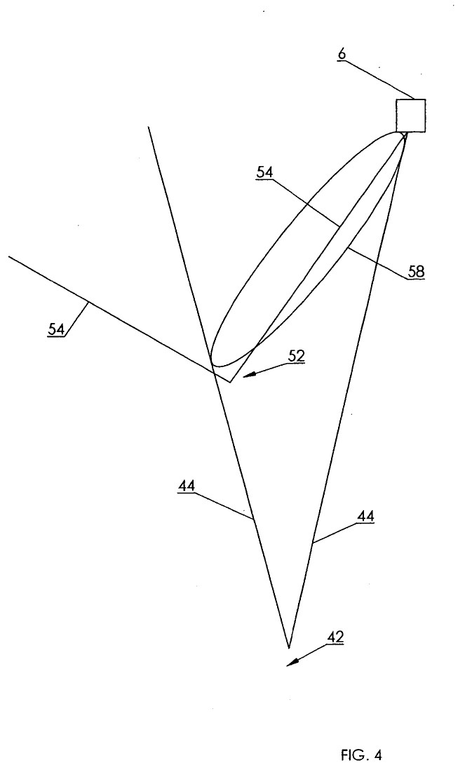

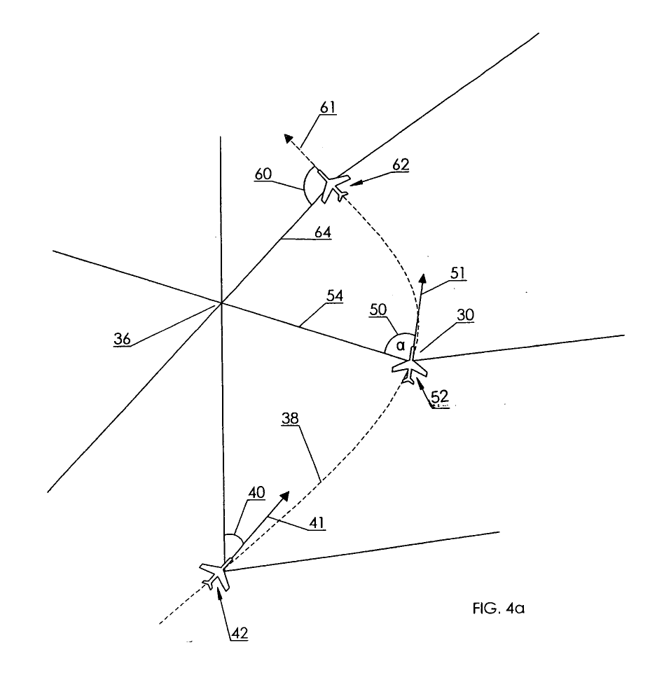

Turning now to FIG. 4, it is illustrated that the first and second conical surfaces 44 and 54 may be superimposed upon each other utilizing the known positions and speed of the antenna 10 at the first and second positions 42 and 52. When the first and second conical surfaces 44 and 54 are mathematically combined, it will be appreciated that the resulting solution plotting the points common to both surfaces 44 and 54 is an ellipse illustrated as line 58 in FIG. 4. It will be appreciated that solving using the first and second conical surfaces 44 and 54 will therefore define an elliptical path 58 upon which the transmitter is located. A third reading may therefore be taken with the antenna 10 at a third position (not shown) to determine a third conical surface. When the first, second and third conical surfaces are mathematically combined, it will be appreciated that the point location of the transmitter 6 is the single intersection of all three of these conical surfaces. This single intersection is therefore the location of the transmitter 6. Further measurements and calculations will accordingly also intersect all previous conical surfaces at the same point.

As illustrated in FIG. 4a, an aircraft 30 is shown having a flight path 38 a first second and third positions 42, 52 and 62, respectively. Each of the first second and third positions has an associated forward orientation or velocity vector. Using the above method, a first second and third conical surface 44, 54, and 64 respectively is determined at first second and third angles 40, 50 and 60, respectively from it's associated velocity vector for each of the first second and third positions 42, 52 and 62. The solution of the intersection of the first second and third conical surfaces 44, 54 and 64 may then be solved to locate the position of the target 36.

The above method will be useful where the exact frequency of the transmitter is known. However, in practices the transmitting frequency of the transmitter is not known precisely or may vary slightly. This is due to emergency broadcasting signals being designated within a specified band or inaccuracies in the emergency beacon. In such a circumstance, the measured frequency at the antenna is Doppler shifted from the transmitted frequency by an unknown amount. It is however known that for each possible transmitted frequency related to the measured frequency, a unique conical surface defines the location of the transmitter. Accordingly, where the transmitted frequency is not known, at least three Doppler shift rate of change measurements of the signal are measured as described above. An assumed transmission frequency is provided and the at least three conical surfaces are determined for the at least three measurements. The convergence of the intersection of these three conical surfaces is calculated for the assumed frequency. Where the unique intersection of at least three conical surfaces is not achieved with the assumed frequency it is known that the actual broadcast frequency of the transmitter is not the assumed frequency. A different assumed frequency is then utilized with the same at least three measured Doppler shift rates of change to converge on the unique intersection of the at least three conical surfaces. Accordingly, what is to be solved for the above problem is the actual broadcast frequency of the transmitter 6 and the position of the transmitter given the knowledge of the at least three Doppler shift rate of change measurements and their associated known positions and speeds. Mathematical methods of solving this problem are well known and include computational geometry as well as other methods. Accordingly it will be observed that by measuring at least three Doppler shift rates of change at three unique speeds and locations, both the actual broadcast frequency and the location of the transmitter may be calculated.

It will be appreciated that although the above method may be utilized with only three frequency measurements, inaccuracies in these measurements or fluctuations in the broadcast frequency may hinder the calculation of a precise location of the transmitter from three measurements alone. In such a case, solving the above mathematical model will produce a location range of the transmitter. Further measurements may thereafter be incorporated into the mathematical model to converge the location range to the position of the transmitter.

In a further embodiment of the above method, the measured frequency of the first measurement may be utilized to narrow the frequency scanning band for subsequent measurements. Based upon the first frequency measurement, it is known, due to knowing the instantaneous speed of the aircraft what the maximum Doppler shifted frequency of the measured frequency is from the broadcast frequency. This narrowed range of frequencies is provided by calculating the actual frequencies assuming that the aircraft is flying both directly towards and away from the transmitter. These two extremes will provide the narrowed range of frequencies of the actual broadcast frequency. Further measurements may therefore be limited to this narrowed band.

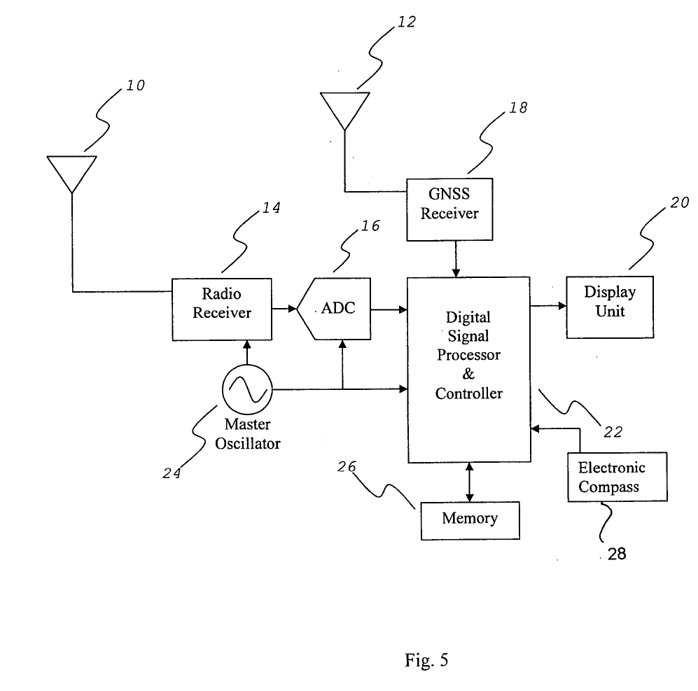

Turning now to FIG. 5, an exemplary non-limiting system utilizing the above method is shown for determining the location of a transmitter. The system may include a master oscillator 24 which provides a very stable reference and synchronization to the radio receiver 14, analog to digital converter (ACD) 16 and digital signal processing (DSP) controller 22. The antenna 10 is connected to the radio receiver 14. The antenna 10 may be a single monopole antenna or alternatively multi-antenna array such as for example a phased array antenna. The radio receiver 14 is a standard superhetrodyne type receiver that down converts the received signal to an intermediate frequency (IF). This IF signal is sampled by the ADC 16 and converted into digital information. The DSP controller 22 processes the sampled digital information to very accurately determine the exact frequency of the received homing signal. The measured frequency along with the position from the GNSS Receiver 18 is time stamped and stored in memory 26 for further processing. The DSP controller 22 later retrieves the stored data to calculate the ‘best fit’ positional solution for the target emergency transmitter. This position solution is sent to the display unit 20. The system may also include an electronic compass 28 for measuring the orientation of the receiver antenna. The DSP controller 22 uses the orientation of the antenna 10 as provided by the electronic compass 28 to determine the direction to the target.

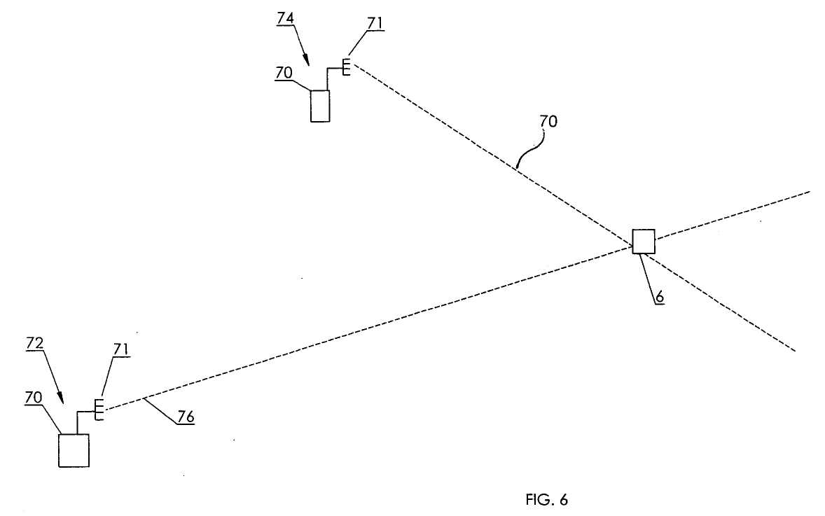

Turning to FIG. 6, a further embodiment of the present invention is illustrated in which a receiver system 70 having a directional antenna 71, such as, for example, as described above is handheld in a ground search scenario for locating a transmitter 6. The receiver 70 will continually or periodically receive the distress signal from the emergency beacon 6 to determine the direction to the transmitter and it's own relative orientation and save this information along with its GNSS position information. The receiver 70 will, for example measure the bearing to the transmitter from the directional antenna 71 from at least two positions 72 and 74 as determined by the GNSS information. The first and second bearings'76 and 78 corresponding to the first and second positions 72 and 74 may then be utilized to calculate the position of the emergency beacon transmitter 6. The accuracy and resolution of the position of the emergency beacon will improve as the search personnel gets closer and as more data points are collected.

The current invention is not intended to be limited to the embodiments described. As will be appreciated, the above method may be utilized with a plurality of different data received at the antenna. Examples of such data may include frequency of the received signal, direction of the received signal, time of arrival of the received signal, position of the receiver, velocity of the receiver, vector of the receiver and orientation of the receiving antenna. Utilization of a system as set out above of any of these or other types of data received at the single receiver at a plurality of positions may stored in memory of the receiver system and used to calculate the unique location of the transmitter.

While specific embodiments of the invention have been described and illustrated, such embodiments should be considered illustrative of the invention only and not as limiting the invention as construed in accordance with the accompanying claims.

What is claimed is:

1. A method of locating a transmitter, the method comprising:
providing a receiver adapted to receive signals from said transmitter;
acquiring a plurality of data points relating to the position of the transmitter, each of said plurality of data points corresponding a unique location of said receiver;
calculating the location of the transmitter using said plurality data points.

2. The method of claim I wherein said plurality of data points represent a measured frequency of a signal transmitted by said transmitter.

3. The method of claim 2 wherein said plurality of data points comprises at least three measured frequencies.

4. The method of claim 2 wherein said plurality of measured frequencies each includes an associated speed and position of said receiver.

5. The method of claim 4 wherein said calculating comprises utilizing said plurality of measured frequencies and their corresponding speed and position of said receiver so as to calculate the position of said transmitter.

6. The method of claim 5 wherein said calculating comprises:
assuming a transmitted frequency of said transmitter based upon said speed of said receiver;
for each of said plurality of measured frequencies calculating an angle of orientation of said transmitter relative to said receiver utilizing the Doppler shift of said measured frequency relative to said assumed transmitted frequency, said angle orientation defining a conical surface; and
calculating the intersection of said plurality of said conical surfaces to determine said location of said transmitter.

7. The method of claim 6 wherein said calculating the intersection utilizes a computer.

8. The method of claim 7 wherein said calculating is performed using computational geometry.

9. The method of claim 1 wherein said transmitter comprises an emergency beacon.

10. The method of claim 2 wherein said receiver is mounted on a search and rescue aircraft.

11. The method of claim 1 wherein each of said plurality of data points represents a direction of said transmitter relative to said receiver at a unique location of said receiver.

12. The method of claim 11 wherein said receiver comprises a direction finding antenna adapted to determine the angle of said transmitter relative to said receiver.

13. The method of claim 12 wherein said receiver has a phased array antenna.

14. The method of claim 11 wherein said receiver has an electronic compass for measuring an orientation of the receiver.

15. The method of claim 11 wherein said plurality of data points comprises at least two data points.

16. The method of claim 14 wherein said calculating comprises calculating the intersection 5 of said at least two directions.

17. An apparatus for locating a transmitter, the apparatus comprising:
an antenna adapted to receive signals from said transmitter;
a receiver adapted to receive a plurality of signals from said antenna;
a memory adapted to store said plurality signals received from said receiver, said plurality signals representing a plurality of data points relating to the position of said transmitter, each of said plurality of data points corresponding a unique location of said receiver;
a processor for calculating the location of the transmitter using said plurality data points stored in said memory; and
an output for outputting the location of said transmitter as calculated by said processor.

18. The apparatus of claim 17 further comprising a global positioning receiver for receiving data representing the global position of said receiver, wherein said processor utilizes said data representing the global position of said receiver to calculate the global position of said transmitter.
